(19) United States
(12) Patent Application Publication
(10) Pub. No.: US 2026/0326532 A1
(43) Pub. Date: Oct. 22, 2026

(54) FLOW RESTRICTION PIPE FOR VEHICLE

(71) Applicant: TOYOTA JIDOSHA KABUSHIKI KAISHA, Aichi-ken (JP)

(72) Inventor: Nao IKEDA, Toyota-shi (JP)

(21) Appl. No.: 19/406,939

(22) Filed: Dec. 3, 2025

(30) Foreign Application Priority Data
Apr. 21, 2025 (JP) 2025-069239

(51) Int. Cl. B60K 11/02; F01P 3/20; F01P 7/14

(52) U.S. Cl. CPC B60K 11/02; F01P 3/20; F01P 2007/143

(57) ABSTRACT

The flow restriction pipe includes a main body pipe and a sleeve pipe. The main body pipe includes a pair of large diameter pipe portions, a small diameter pipe portion, and a steeply enlarged portion. The pair of large diameter pipe portions are disposed at both ends of the main body pipe in a longitudinal direction. The small diameter pipe portion is connected to the pair of large diameter pipe portions. The small diameter pipe portion is longer in the longitudinal direction than the pair of large diameter pipe portions. The steeply enlarged portion is formed in a connection region between the small diameter pipe portion and the large diameter pipe portion. The steeply enlarged portion is also oriented perpendicular to a longitudinal axis. The sleeve pipe houses the main body pipe over an entire length of the main body pipe in the longitudinal direction.

### CROSS REFERENCE TO RELATED APPLICATION

This application claims priority to Japanese Patent Application No. 2025-069239, filed on Apr. 21, 2025, which is incorporated herein by reference in its entirety including the specification, claims, drawings, and abstract.

### TECHNICAL FIELD

The present specification discloses a flow restriction pipe that is installed as part of an in-vehicle piping.

### BACKGROUND

JP 2022-120504 A discloses a cooling circuit pipe. This pipe is installed in a cooling circuit through which the refrigerant of the vehicle circulates. In JP 2009-281069 A, a pressure loss part is provided in a water supply facility. The water absorption pipe is bifurcated, and a pressure loss portion is provided in one pipe. The flow rate can be narrowed by intentionally generating a pressure loss by the pressure loss portion. The pressure loss portion is a tubular body and has a reduced diameter portion. By providing the pressure loss portion in one pipe, the flow rate to the other pipe can be relatively increased.

The flow rate limiting pipe includes a large-diameter portion and a small-diameter portion. As the shape of the transition portion between the large diameter portion and the small diameter portion becomes steeper, a larger pressure loss is obtained along with the generation of the vortex. For example, a larger pressure loss can be obtained when the transition portion has a stepped cross-sectional shape than when the transition portion has a tapered cross-sectional shape.

Here, the devices connected to both ends of the flow rate limiting pipe body relatively move with the vibration of the vehicle. Along with this relative movement, a bending load is applied to the flow restriction pipe body. At this time, stress concentrates on the stepped portion based on the shape of the flow rate limiting pipe body.

Therefore, the present specification discloses a flow restriction pipe for a vehicle capable of relaxing stress concentration as compared with the related art.

### SUMMARY

The present specification discloses a flow restriction pipe for a vehicle. A hose for circulating refrigerant is connected to the flow restriction pipe. The flow restriction pipe includes a main body pipe and a sleeve pipe. The main body pipe includes a pair of large diameter pipe portions, a small diameter pipe portion, and a steeply enlarged portion. The pair of large diameter pipe portions are disposed at both ends of the main body pipe in a longitudinal direction. The small diameter pipe portion is connected to the pair of large diameter pipe portions. The small diameter pipe portion is longer in the longitudinal direction than the pair of large diameter pipe portions. The steeply enlarged portion is formed in a connection region between the small diameter pipe portion and the large diameter pipe portion. The steeply enlarged portion is also oriented perpendicular to a longitudinal axis. The sleeve pipe houses the main body pipe over an entire length of the main body pipe in the longitudinal direction.

According to the above configuration, the main body pipe is reinforced by the sleeve pipe over the entire length.

In addition, in the above configuration, extension portions may be formed at both ends in the longitudinal direction of the sleeve pipe. The extension portions extend to an outward side in the longitudinal direction relative to the pair of large diameter pipe portions. Further, a connection portion with the hose is formed in the extension portion.

According to the above configuration, a direct connection between the hose and the main body pipe is avoided. Therefore, the bending load input from the hose is distributed to the sleeve pipe.

In the above configuration, the connecting portion may be a retaining ring. The retaining ring is expanded in diameter in an annular shape. And the hose is inserted into the retaining ring.

According to the above configuration, the sleeve pipe and the hose are engaged with each other at the connection portion separated from the main body pipe. This avoids the compression load associated with the engagement being directly applied to the main body pipe.

In the above configuration, the sleeve pipe may have a constant diameter over portions covering the large diameter pipe portions and a portion covering the small diameter pipe portion.

According to the above configuration, stress concentration in the sleeve pipe is suppressed.

In the above configuration, an inner circumferential surface of the sleeve pipe and an outer circumferential surface of the large diameter pipe portion may be sealed with an adhesive over an entire circumference.

Since the extension portion protrudes outward from the large diameter pipe portion, the inner circumferential surface of the extension portion serves as a liquid contact surface. By sealing the inner circumferential surface of the sleeve pipe and the outer circumferential surface of the large diameter pipe portion over the entire circumference, leakage of the refrigerant into the gap between the sleeve pipe and the small diameter pipe portion is suppressed.

According to the flow restriction pipe for a vehicle disclosed in the present specification, it is possible to alleviate stress concentration as compared with the related art.

### BRIEF DESCRIPTION OF DRAWINGS

Embodiments of the present disclosure will be described based on the following figures, wherein:

FIG. 1 is a diagram illustrating a refrigerant circuit;

FIG. 2 is a perspective view illustrating the flow rate restriction pipe according to the present embodiment;

FIG. 3 is a side view illustrating the flow rate restriction pipe according to the present embodiment;

FIG. 4 is a cross-sectional view taken along line A-A of FIG. 2; and

FIG. 5 is an enlarged A-A cross-sectional view of the periphery of the end portion of the main body pipe.

### DESCRIPTION OF EMBODIMENTS

Hereinafter, a flow rate limiting pipe body for a vehicle according to an embodiment will be described with reference to the drawings. The shapes, materials, numbers, and numerical values described below are for illustrative purposes only. These shapes and the like can be appropriately changed according to the specification of the flow rate limiting pipe body. In the following description, the same reference numerals denote the same elements in all the drawings.

### 1. Refrigerant Circuit

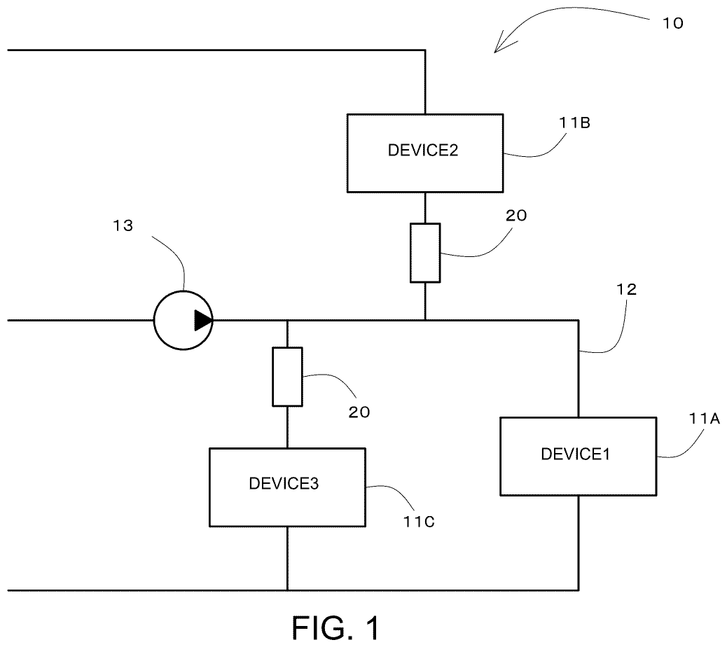

FIG. 1 illustrates a part of a refrigerant circuit 10. The refrigerant circuit 10 is mounted on a vehicle. In the refrigerant circuit 10, the refrigerant flows through the hose 12. The hose 12 is made of a resin material such as rubber. The hose 12 is connected to the plurality of devices 11A to 11C. The devices 11A to 11C are, for example, a battery, a DC/DC converter, and a transaxle. In the cooling circuit, the devices 11A to 11C are cooled by the refrigerant.

When the coolant is supplied to the devices 11A to 11C by the water pump 13, the flow restriction pipe 20 is used to adjust the flow rate of the coolant to each of the devices 11A to 11C. For example, in order to reduce the refrigerant flow rate to the devices 11B and 11C as compared with the device 11A, the flow restriction pipe 20 is connected between the water pump 13 and the devices 11B and 11C.

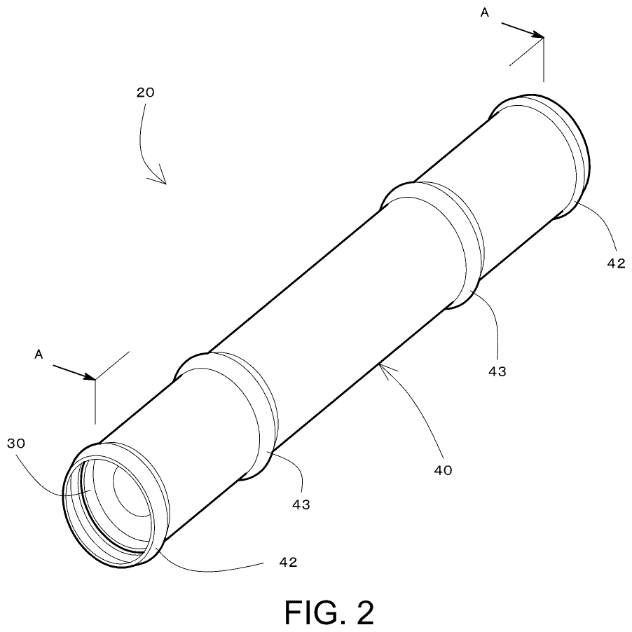

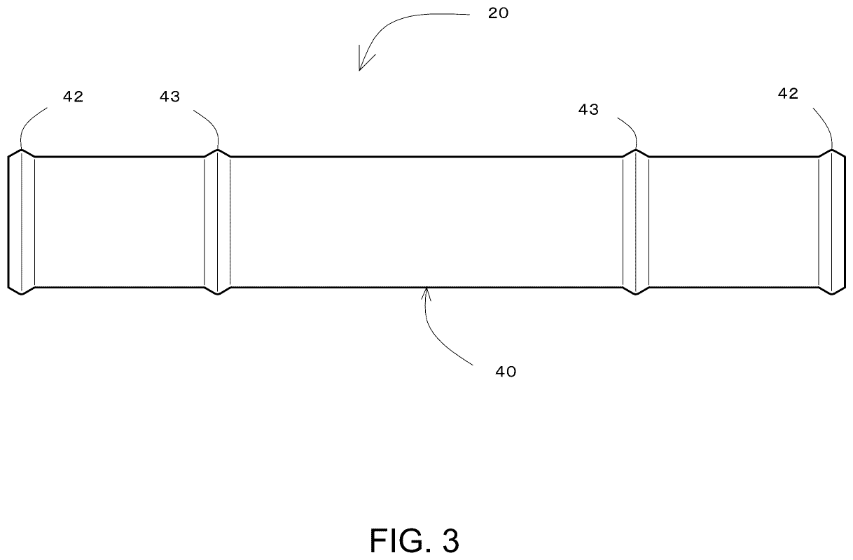

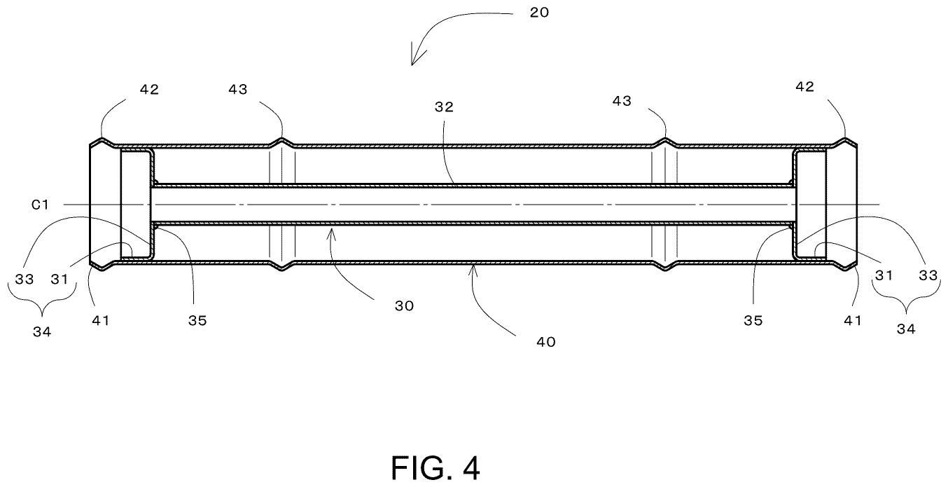

FIG. 2 illustrates a perspective view of the flow restriction pipe 20 according to the present embodiment. Also illustrated in FIG. 3 is a side view of the flow restriction pipe 20. The flow restriction pipe 20 is a substantially cylindrical pipe body, and both ends thereof in the longitudinal direction are opened. FIG. 4 illustrates an A-A cross section of FIG. 2. As illustrated in FIG. 4, the flow restriction pipe 20 includes a main body pipe 30 and a sleeve pipe 40.

### 2. Main Body Pipe

The main body pipe 30 includes a large diameter pipe portion 31, a small diameter pipe portion 32, and a steeply enlarged portion 33. The large diameter pipe portion 31 has a diameter larger than that of the small diameter pipe portion 32. A pair of large diameter pipe portions 31 are provided at both ends of the main body pipe 30 in the longitudinal direction.

The small diameter pipe portion 32 is longer than the large diameter pipe portion 31 in the longitudinal direction. For example, the small diameter pipe portion 32 is a main portion of the main body pipe 30. The large diameter pipe portions 31 is connected to both ends of the small diameter pipe portion 32 in the longitudinal direction via the steeply enlarged portion 33.

The steeply enlarged portion 33 is provided in a connection region between the large diameter pipe portion 31 and the small diameter pipe portion 32. In other words, the outer end of the small diameter pipe portion 32 in the longitudinal direction and the inner end of the large diameter pipe portion 31 in the longitudinal direction are connected to the steeply enlarged portion 33.

For example, the steeply enlarged portion 33 is oriented perpendicular to the longitudinal axis C1. That is, the longitudinal direction end portion of the main body pipe 30 has a stepped cross-sectional shape due to the large diameter pipe portion 31, the steeply enlarged portion 33, and the small diameter pipe portion 32.

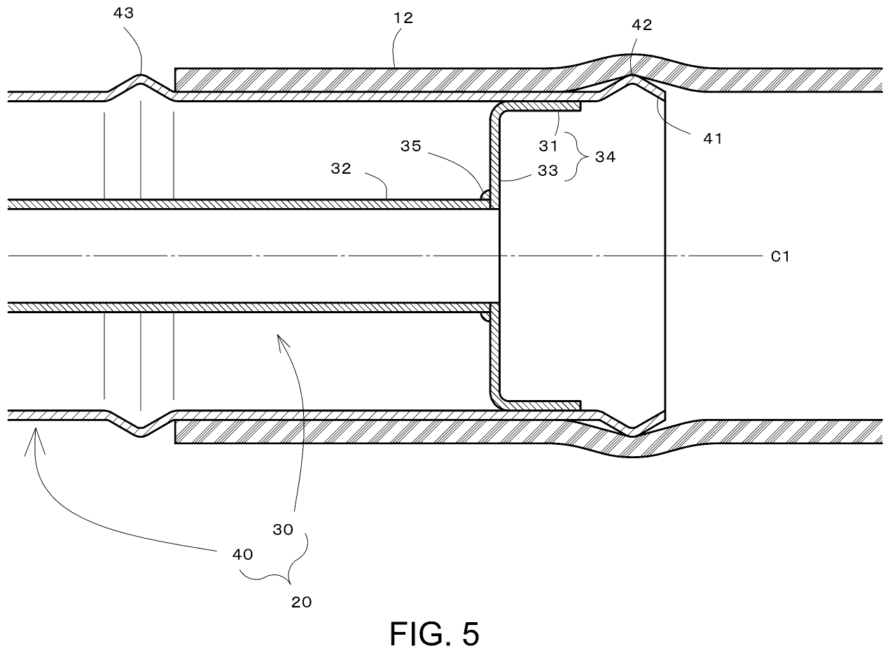

In FIG. 5, an enlarged view of the longitudinal end of the flow restriction pipe 20 is illustrated. For example, the main body pipe 30 includes a small diameter pipe portion 32 and a terminal ring 34. The terminal ring 34 is an annular member including a large diameter pipe portion 31 and a steeply enlarged portion 33. The terminal ring 34 and the small diameter pipe portion 32 are butted and brazed. That is, the welded portion 35 is installed in an annular shape at the joint portion between the small diameter pipe portion 32 and the terminal ring 34, so that the terminal ring 34 and the small diameter pipe portion 32 are sealed.

As illustrated in FIG. 5, a hose 12 is attached to both longitudinal ends of the flow restriction pipe 20. When the devices 11A to 11C (see FIG. 1) connected to the hose 12 and the water pump 13 relatively move due to vehicle vibration or the like, a bending load is input to the flow restriction pipe 20. When a bending load is applied to the main body pipe 30, stress is concentrated on the welded portion 35 in terms of structure. To alleviate this stress concentration, the main body pipe 30 is reinforced with the sleeve pipe 40.

The refrigerant flowing into the main body pipe 30 from the large diameter pipe portion 31 is restricted in flow by the steeply enlarged portion 33. For example, a vortex is generated at a corner portion formed by the large diameter pipe portion 31 and the steeply enlarged portion 33. This vortex causes a pressure loss. The refrigerant whose pressure has been attenuated flows into the small diameter pipe portion 32. From such a function, the main body pipe 30 can be regarded as a pressure loss body.

### 3. Sleeve Pipe

Referring to FIG. 4, the sleeve pipe 40 accommodates the main body pipe 30 over the entire longitudinal length of the main body pipe 30. The sleeve pipe 40 is cylindrical, and the pie diameter is kept constant except for the retaining ring 42 and the stopper ring 43. That is, the sleeve pipe 40 has a constant pipe diameter over a portion covering the large diameter pipe portion 31 and a portion covering the small diameter pipe portion 32 of the main body pipe 30. By setting the pipe diameter of the sleeve pipe 40 to a constant value, stress concentration is suppressed when a bending load is input.

For example, the inner diameter of the sleeve pipe 40 may be substantially the same as the outer diameter of the large diameter pipe portion 31. For example, an adhesive is filled over the entire circumference between the inner circumferential surface of the sleeve pipe 40 and the outer circumferential surface of the large diameter pipe portion 31. That is, the gap between the sleeve pipe 40 and the large diameter pipe portion 31 is sealed over the entire circumference by the adhesive. As described later, the inner circumferential surface of the extension portion 41 of the sleeve pipe 40 is a liquid contact surface. Since the gap between the sleeve pipe 40 and the large diameter pipe portion 31 is sealed, the refrigerant is prevented from entering the gap between the small diameter pipe portion 32 and the sleeve pipe 40.

Referring to FIGS. 4 and 5, extension portions 41 are provided at both ends of the sleeve pipe 40 in the longitudinal direction. The extension portion 41 extends further outward in the longitudinal direction than the large diameter pipe portion 31. The extension portion 41 includes a connection portion with the hose 12. As a connecting portion, a retaining ring 42 is formed in the extension portion 41.

The retaining ring 42 is an annular portion having a chevron-shaped cross section and having an increased diameter from the sleeve pipe 40. The hose 12 is inserted into the flow restriction pipe 20 so as to cover the sleeve pipe 40. When the hose 12 is inserted into the extension portion 41, it climbs over the retaining ring 42. That is, the diameter of the hose 12 is expanded by the retaining ring 42. The retaining ring 42 is biased radially inward by the elasticity of the hose 12. This urging force is input over the entire circumference of the retaining ring 42. As a result, the extension portion 41 and the hose 12 are sealed.

By providing the retaining ring 42 at a position separated from the main body pipe 30, a direct input of the elastic force of the hose 12 to the main body pipe 30 (particularly, the large diameter pipe portion 31) is avoided.

Since the extension portion 41 protrudes outward in the longitudinal direction from the large diameter pipe portion 31 of the main body pipe 30, the inner circumferential surface of the extension portion 41 becomes a liquid contact surface. As described above, the inner circumferential surface of the sleeve pipe 40 and the outer circumferential surface of the large diameter pipe portion 31 are sealed with the adhesive over the entire circumference. Therefore, leakage of the refrigerant into the gap between the sleeve pipe 40 and the small diameter pipe portion 32 is suppressed.

A stopper ring 43 is formed on the sleeve pipe 40. The stopper ring 43 is formed at a central portion in the longitudinal direction with respect to the retaining ring 42. Similarly to the retaining ring 42, the stopper ring 43 is an annular portion having a chevron-shaped cross-section and having an increased diameter from the sleeve pipe 40. The terminal end of the hose 12 abuts against the stopper ring 43. The stopper ring 43 clarifies the insertion depth of the hose 12 into the sleeve pipe 40.

The present disclosure is not limited to the present embodiments described above, and includes all changes and modifications without departing from the technical scope or the essence of the present disclosure defined by the claims.

1. A flow restriction pipe for a vehicle, to which a hose for circulating refrigerant is connected, the flow restriction pipe comprising:
a main body pipe comprising:
a pair of large diameter pipe portions disposed at both ends of the main body pipe in a longitudinal direction;
a small diameter pipe portion connected to the pair of large diameter pipe portions and longer in the longitudinal direction than the pair of large diameter pipe portions; and
a steeply enlarged portion formed in a connecting region of the small diameter pipe portion and the large diameter pipe portion, and oriented perpendicular to a longitudinal axis; and
a sleeve pipe that houses the main body pipe over an entire length of the main body pipe in the longitudinal direction.

2. The flow restriction pipe for a vehicle according to claim 1, wherein
extension portions are formed at both ends in the longitudinal direction of the sleeve pipe, and the extension portions extend to an outer side in the longitudinal direction relative to the pair of large diameter pipe portions; and
a connection portion with the hose is formed in the extension portion.

3. The flow restriction pipe for a vehicle according to claim 2, wherein
the connection portion is a retaining ring, the retaining ring is expanded in diameter in an annular shape, and the hose is inserted into the retaining ring.

4. The flow restriction pipe for a vehicle according to claim 3, wherein
the sleeve pipe has a constant diameter over portions covering the large diameter pipe portions and a portion covering the small diameter pipe portion.

5. The flow restriction pipe for a vehicle according to claim 4, wherein
an inner circumferential surface of the sleeve pipe and an outer circumferential surface of the large diameter pipe portion are sealed with an adhesive over an entire circumference.
